(19) United States
(12) Patent Application Publication
(10) Pub. No.: US 2004/0165149 A1
(43) Pub. Date: Aug. 26, 2004

(54) Film advance mechanism for motion picture apparatus

(76) Inventor: Donald L. Holst JR., Canyon Country, CA (US)

Correspondence Address: CHRISTIE, PARKER & HALE, LLP, PO BOX 7068, PASADENA, CA, 91109-7068, US

(21) Appl. No.: 10/784,057

(22) Filed: Feb. 20, 2004

Related U.S. Application Data
(60) Provisional application No. 60/450,160, filed on Feb. 25, 2003.

(51) Int. Cl. G03B 21/18

(52) U.S. Cl. 352/152

(57) ABSTRACT

A motion picture apparatus and method for intermittently advancing motion picture film by forced air. The film is initially placed into successive loops formed by closure of a rotary air valve. The loops and thus the film are advanced through the projector or camera pathway by a forced air blower which propels the successive loops through a projection pathway by opening of the rotary air valve. The film loop is metered by timing the opening and closing of the rotary air valve with the opening and closing of the shutter of the motion picture apparatus.

### CROSS-REFERENCE TO RELATED APPLICATION(S)

This application claims priority of Provisional Patent Application No. 60/450,160 filed Feb. 25, 2003.

### BACKGROUND OF THE INVENTION

The field of the present invention relates to film advance mechanisms for motion picture projection and photography systems. Motion picture projectors have been utilized in a variety of situations in addition to their familiar use in movie theaters. Thrill rides at theme parks utilize motion picture projectors to simulate surroundings and enhance the true to life look and feel of a particular ride. Planetarium projectors are used to project realistic images onto a large, domed projection screen.

These conventional projectors have numerous mechanical and electrical components to control film speed, film placement and the particularly difficult task of rewinding the film. Accordingly, the conventional projectors often develop operational problems requiring frequent maintenance and repair work. These problems idle the particular projector and may even shut down the theater or thrill ride. Conventional motion picture projectors may also employ computer actuated controls, requiring additional operator skills to maintain and repair.

Previous film advance mechanisms for motion picture apparatus require a loop former/flipper that allows the film to form a loop. Once the loop is fully formed, the loop former/flipper is rotated by a rotating cam device. This configuration gives the film a push and causes the film loop to move across a linear sprocket and aperture. The loop former/flipper is returned to the loop forming position via a pair of springs. The loop former/flipper is the metering or timing method to allow the film to move while the shutter is closed. Details of this prior arrangement are disclosed in Applicant's U.S. Pat. Nos. 5,341,182; 5,633,596 and 5,841,541, the disclosures of which are incorporated herein by reference.

Drawbacks of these prior art systems include potential damage to the film due to moving parts touching the film as it is advanced. In addition because there are high accelerating flipper devices, noise generated can reach levels which are unacceptable. In addition because there are a number of moving parts, additional maintenance and expense is associated with maintaining these systems.

Another disadvantage is that since there are a number of mechanical parts, the loop former/flippers must be retracted during high speed rewind or high speed fast forward. Consequently a need exists for an improved film advance mechanism for motion picture apparatuses which eliminates the problems associated with prior film advance mechanisms.

### SUMMARY OF THE INVENTION

The present invention is directed to a film advance mechanism for a motion picture apparatus which improves upon prior film advance mechanisms. Specifically a new configuration has been designed, known as an air pulse linear loop configuration which utilizes existing air flow and air flow configuration to accomplish the task of prior former/flipper assemblies. The air pulse linear loop configuration is achieved by placing a timed rotary air valve, instead of a former/flipper assembly, to cause a bulk of the air to pass through the valve when the loop in the film is in position to be moved such that the film loop can be propagated down or across a linear sprocket without touching the film with anything but air. The loop is formed in the low pressure area created when the rotary air valve is in the closed position. The film loop is metered by the timing of the rotary air valve opening and closing relative to the opening and closing of the shutter.

Advantages of the present invention include the film not being touched by any moving parts which could cause damage to the film. Another advantage is the elimination of additional moving parts in the loop former/flipper device, and no requirement to retract mechanical loop former/flippers during high speed rewind or high speed fast forward. The air pulse linear loop system eliminates the need for cams and flipping devices that are high wear and high replacement cost items. The rotary air valve never requires replacement. Since there are no high accelerated flipping devices, the noise from these devices is eliminated.

### BRIEF DESCRIPTION OF THE DRAWINGS

Accordingly, it is an object of the present invention to provide a motion picture apparatus with an improved film advance arrangement, but other and more detailed objects and advantages will appear to those skilled in the art from the following description and the accompanying drawings, wherein:

FIG. 1 is a side cut-away view of a prior art embodiment illustrating the direction of movement of the film with arrows indicating the respective rotational directions of cam and sprockets.

FIG. 2 is a side cut-away view of the prior art embodiment taken later in time compared to FIG. 1 illustrating the direction of the loop and air flow (with arrows) through the motion picture projector.

FIG. 3 is also a side cut-away view of the prior art embodiment showing the sequential movement of the loop in the film from its position in FIG. 2 and showing (with arrows) the flow of air.

FIG. 4 is another side cut-away view of the prior art embodiment illustrating the motion picture apparatus rewinding the film with arrows showing the rotational direction of the sprockets.

FIG. 5A is a top view of the gate of the motion picture apparatus of the present invention that temporarily secures or registers the film between the film input and the film output.

FIG. 5B is a side elevation view of the gate.

FIG. 5C is an elevation view from another side of the gate.

FIG. 6 is a rear elevation view of one embodiment of the motion picture apparatus illustrating the position of the shutter, a multi-speed motor and the coupling of the motor to the shutter and the input and output sprockets.

FIG. 7 is a side view of the prior art film advance mechanism showing two positions of the flipper and illustrating the projection lens, a cut-away view of the motor and schematically illustrating the light source.

FIG. 8 is a side view of the prior art illustrating an alternate projector embodiment.

FIG. 9 is a side view of the air pulse film advance mechanism of the present invention.

### DETAILED DESCRIPTION OF THE DRAWINGS

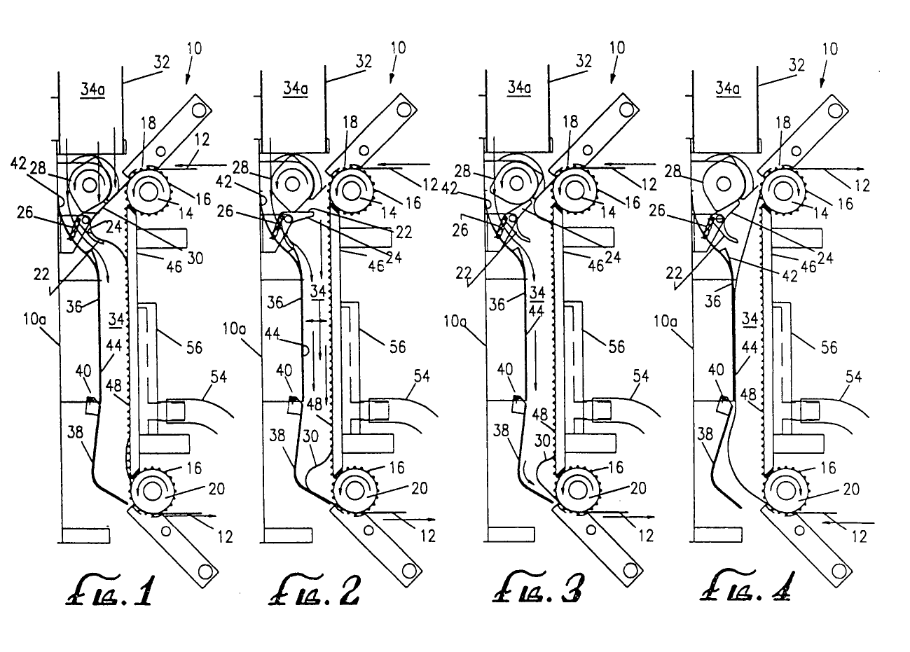

Referring now to the drawings, FIG. 1 illustrates the prior art motion picture apparatus 10 and a portion of the support housing 10a. As shown initially in FIG. 1, the motion picture film 12 enters the housing 10a by a cylindrical input sprocket 14. Sprocket teeth 16 on the sprocket 14 mesh with perforated openings 18 paired at regular intervals along the length of the film 14. At another end of the housing 10a, the film 12 is taken up by a cylindrical output sprocket 20 also having sprocket teeth 16 on the circumference of the sprocket 20.

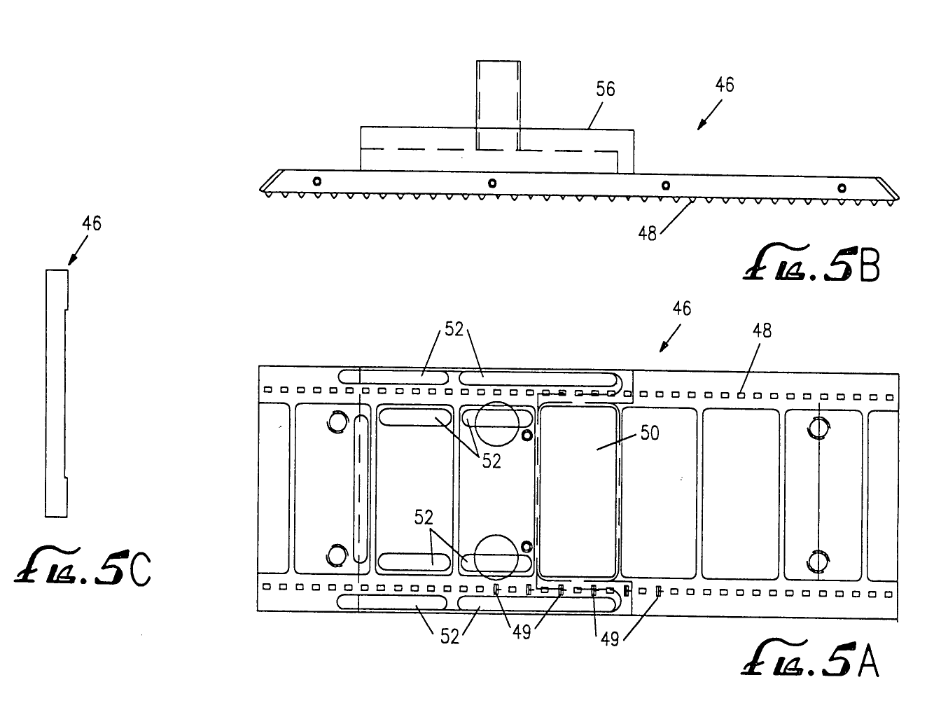

The film 12 next engages the flipper 22 which has a crescent shaped surface 24 feature to engage the film 12. A spring 26 biases the flipper 22 so that the surface 24 contacts the film 12 after the film 12 enters the housing 10a. As shown in FIG. 1, a cam 28 is positioned directly above the flipper 22. As the cam 28 is rotated, its surfaces strike the flipper 22 to actuate up and down movement of the flipper 22 as shown later in sequence in FIGS. 2 and 3. The flipper 22 thereby places a loop 30 in the film 12 as illustrated in FIG. 1.

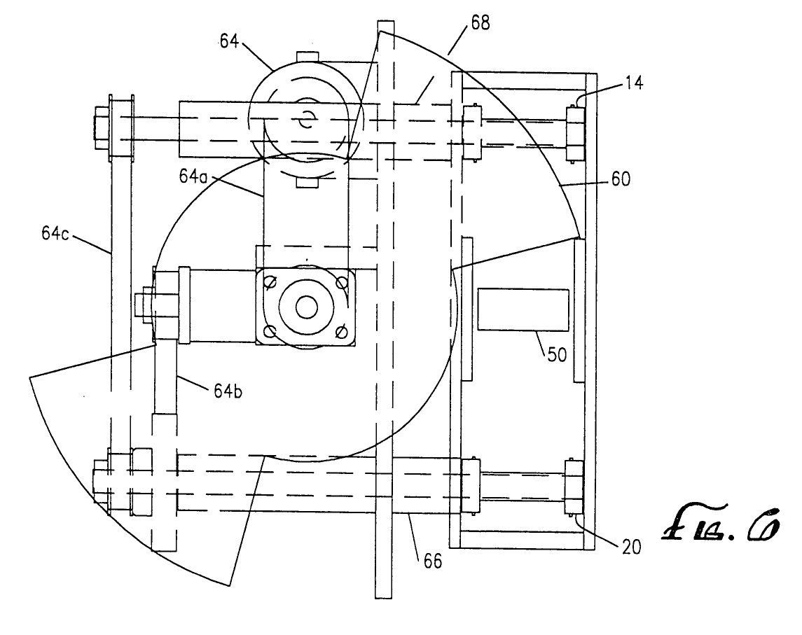

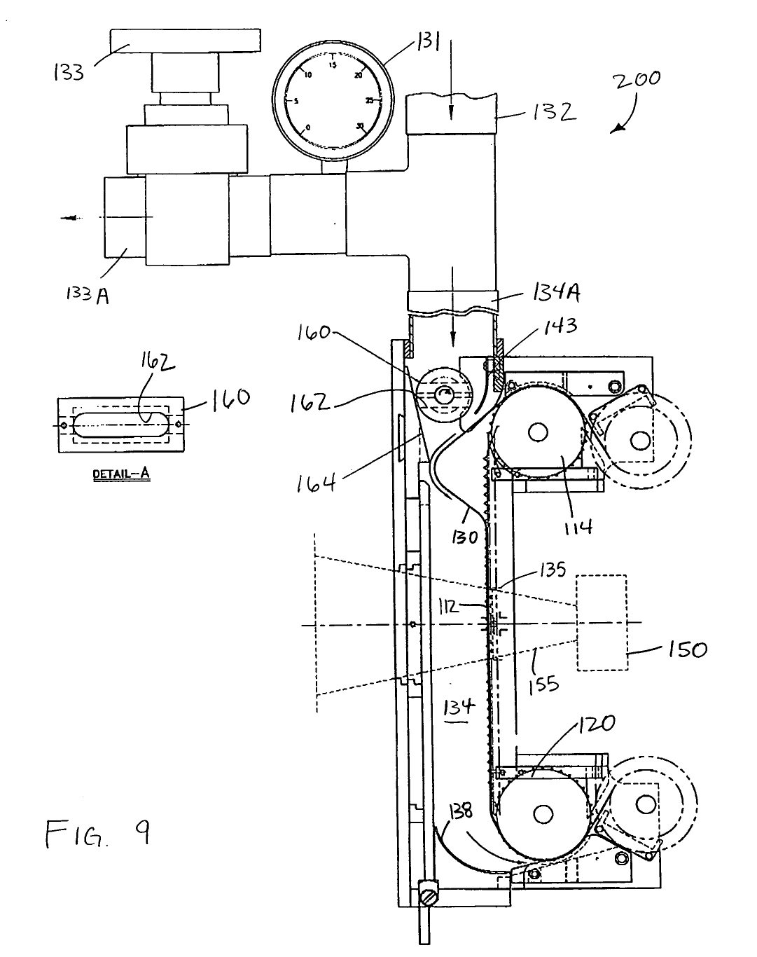

A multi-stage air blower 32, shown schematically in FIGS. 1-4, is placed above the cam 28 to force air out through the blower exit 34a downward past the cam 28 and the flipper 22. The air blower 32 may be a Rotron blower model no. SL2P2 which is adjusted to input an air pressure equivalent to approximately fifteen inches of water. An alternate air pressure adjustment mechanism may be employed such as a pressure controller as disclosed in the embodiment of FIG. 8 below. As the film 12 is advanced, a series of loops 30 (and thus the film 12) is propelled along a first pathway 34 by air pressure from the air blower 32 as shown in FIGS. 2 and 3 illustrating the sequential movement of a loop 30.

The speed and size of the loop may be selected depending upon the size, speed and type of film but is generally selected such that the film is advanced one frame by the travel of a loop 30 from its position adjacent flipper 22 (as shown in FIG. 1) and its position adjacent the output sprocket 20 (as shown in FIG. 2). In sequence, (1) with the shutter closed the film is advanced one frame by the travel of one loop from the positions illustrated from FIG. 1 to FIG. 2, (2) with the frame in position, the shutter is opened and film exposed, and (3) the shutter is closed and another loop is passed to advance the film one frame (repeating the process).

Spanning from just adjacent to the blower exit 34a past the flipper 22 is the air foil 36 which forms one side of the first the pathway 34. A guide member 38 is secured to the lower end of the air foil 36 by a hinge 40 so the guide member 38 can pivot about the air foil 36 to facilitate the film supply operation or a film rewind operation. The guide member 38 may be “L” shaped as shown in FIGS. 1-4 or may be substantially straight. The air foil 36 is comprised of first curved surfaces 42 starting below the blower 32, the cam 28 and the flipper 22 and is comprised of second planar surfaces 44 along a span of the first pathway 34.

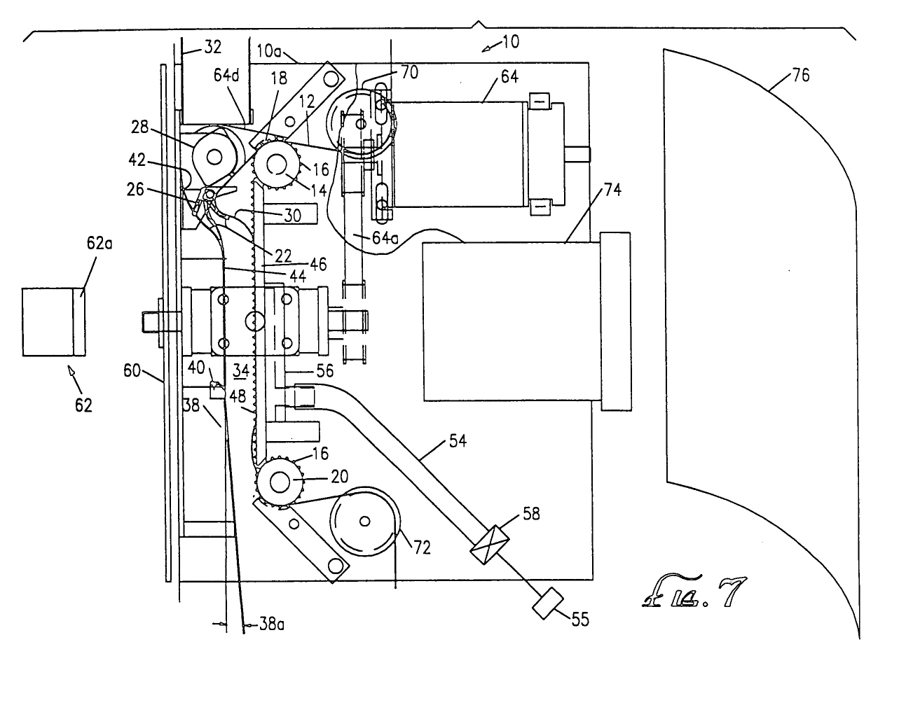

Positioned opposite the air foil 36 is the gate 46 which, in this embodiment, spans between the input sprocket 14 and the output sprocket 20 as shown in FIGS. 1-4. FIGS. 5A and 5C shows the gate 46 has substantially planar surfaces where it mates with the film 12. Two rows of register pins 48 are arranged in a linear fashion along the gate 46 so that pairs of register pins 48 engage the paired perforated openings 18 on the film 12 and securing the film 12 over the projection aperture 50. As shown in FIG. 5A, some register pins 48 have a wider transverse dimension 49 to reduce unwanted sideways motion of the film 12 that causes unwanted flutter of the projected picture.

A plurality of ports 52 are arranged on the gate 46 so that a pressure may be applied to the film 12 through a pressure input line 54 connected to a Rotron blower model no. RDC12HF which supplies the pressure. A jacket 56 surrounds the ports 52 and distributes the pressure to the ports 52. This pressure may be changed from a vacuum pressure to a positive pressure through a switching valve 58, shown schematically in FIG. 7. A vacuum pressure equivalent to approximately ten inches of water has been found to be sufficient to secure the film 12 to the gate 46.

During film advancement, the loops 30 span between the air foil 36 and the gate 46 with a portion of the film 12 over the aperture 50 so that the flow of air from the blower 32 propels the loop 30, in effect forcing the loop 30 through the first pathway 34. Using 70 millimeter film with five perforation advance, a distance of approximately 13/16 of an inch between planar surfaces 44 and the gate 46 is used. The film speed or frame rate can be adjusted to accommodate frame rates of 24, 30, 48 or 60 frames per second.

The guide member 38 may be pivoted toward the gate 34 or pivoted away from the gate 34 as required for film advancement or film rewind. As shown in FIG. 7, a rotated angle 38a of the guide means 38 of between zero degrees and ten degrees is used to provide a path for advancement of the film 12 toward the output sprocket 20.

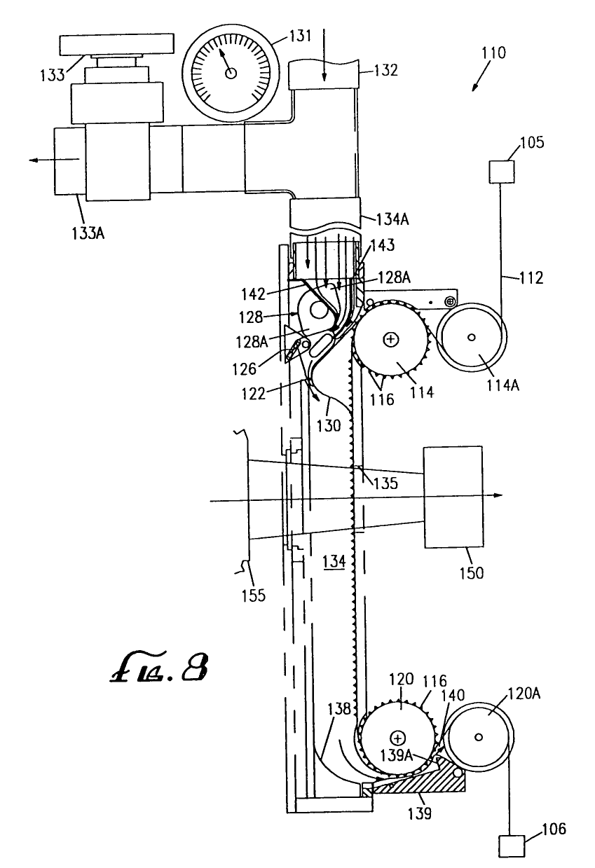

Another feature is shown in FIG. 6, where the multi-speed motor 64 is illustrated with various couplers 64a, 64b and 64c. One feature uses a Torque Systems DC motor model no. MT 3630131AF and may include an encoder to accurately control the operation speed of the apparatus 10. The motor 64 is coupled to the shutter 60 by a first coupler 64a to provide intermittent illumination of the film 12. A second coupler 64b couples the motor 64 to an output driver 66 to transport film 12 from the output sprocket 20. A third coupler 64c couples the output driver 66 to the input driver 68 to transport film 12 from the input sprocket 14. The output driver 66 and the input driver 68 may each employ a clutch mechanism to allow smooth film 12 advancement or rewind.

Referring again to FIG. 7, a fourth coupler 64d is shown coupled to the cam 28 which allows the motor 64 to also propel the cam 28. The light source 62 and first lens 62a, which initially focuses the light onto the film 12, are shown schematically. The input spooler 70 and the output spooler 72, coupled to the film 12, are shown adjacent to the input and output sprockets 14 and 20 respectively for transporting film into or away from the sprockets 14 and 20. The projection lens 74 which projects the illuminated motion picture onto a screen is shown in its preferred location on the housing 10a.

FIG. 8 illustrates another prior art embodiment for a motion picture apparatus 110. With certain difference as noted below, the motion picture apparatus 110 is similar to the motion picture apparatus 10 of FIG. 1. The film 112 is moved past aperture 135. Light from lamp 155 is passed through the film 112 with the projected image focused by lens 150.

In this embodiment, input pressure from blower 132 is controlled by a pressure control valve 133 which bleeds off pressure through an exit line 133a. A film loop 130 is formed in the curved portion of the flipper 122, the flipper 122 being biased in the “lock” position (counter-clockwise as viewed in the figure) by spring 126. As the cam 128 rotates, the flipper 122 is actuated by an extending cam surface 128a (there is an extending cam surface 128a on each side of the cam 128) for releasing a film loop 130 to travel down pathway 134 and past the aperture 135 driven by the air from blower 132 thereby advancing the film. The passage of one loop 130 advances the film one frame. Register pins 148 keep the film in proper alignment as described in previous embodiments. The flow of air from the blower 132 is directed by a series of curved vanes 142, 143. The path for the flow of air is generally illustrated by the arrows in the figure. The vanes 142, 143 direct the flow of air passing therebetween in a direction parallel to the surface of the film loop 130. A smaller portion of the airflow is allowed to pass beneath the vane 142 to impinge directly on the film loop 130. It is believed that this configuration provides for smooth film movement by creating a laminar flow of air over the film to control a positive loop release.

The film tension on the input sprocket 114 is maintained by a roller 114A and the film tension on the output sprocket is maintained by a roller 120A. Film 112 is provided to the input roller 114A from a take-off spool 105 (shown diagrammatically) and taken in from roller 120A by take-up spool 106 (shown diagrammatically). Sprocket teeth 116 on both the input sprocket 114 and the output sprocket 120 mesh with perforated openings paired at regular intervals along the length of the film 130.

A scoop 138 is positioned at the end of the pathway 134 to provide a soft landing of the film loop 130. It is believed that the softer landing will allow for reduced wear on the film (e.g., longer life of film splices) or may eliminate or reduce the need for reverse air pressure for some types of film.

To increase air pressure in the exit from output sprocket 120, a bracket 139 with a lip 139A is provided to form a narrow air gap 140 between the lip 139A and the output sprocket 120. The increase in pressure holds the film 112 firmly on the teeth 116 of the output sprocket 120. The size of the gap 140 may be adjusted by moving the position of the bracket 139. The other elements and features are as described in previous embodiments and are not repeated.

The motion picture apparatus 200 of the present invention is illustrated in FIG. 9. With certain differences noted below, the motion picture apparatus 200 is similar to the motion picture apparatus 110 shown in FIG. 8. The film is moved past aperture 135. Light 155 is moved through the film 112 with the projected image focused by lens 150. In this embodiment, input pressure from blower 132 is controlled by a pressure control valve 133 which bleeds off pressure through an exit line 133A. A film loop 130 is formed by the existing air flow through a timed rotary air valve 160. As air travels down through pathway 134A the timed rotary air valve 160 rotates such that a bulk of the air passes through the valve when the loop 130 is in position to be pulsed and thereby the film loop can be propagated down or across the linear sprocket without touching the film with anything but air.

The rotary air valve 160 has a passage 162 which when rotated accepts the travel of air down passage 134A. The timing of the rotation of the rotary air valve is controlled to advance the film loop as necessary. The loop is formed in the low pressure area created when the rotary air valve is in the closed position. The film loop is metered by the timing of the rotary air valve opening and closing relative to the opening and closing of the shutter. The film frame is presented to the aperture during the open shutter time with less air pressure. This provides a flatter and more consistent film frame presentation. The result being that there is better focus and less breathing.

This configuration runs with lower air pressure, as low as 2 to 3 inches of water compared to pressures as high as 15 inches of water for previous flipping systems, and lower air flow. The film is driven onto the linear sprocket with less force with less resultant wear on the film perforations and the linear sprocket teeth. The film advance mechanism of the present invention allows 2 to 3 times the amount of film passing through the film gate with the same film. This lowers, significantly, film replacement costs. The film advancement mechanism of the present invention also provides a more stable and crisper image for a longer period of time.

Considering the rotary air valve system requires less air pressure and less airflow, a smaller air pull down blower can be utilized. Since there is low pressure in the air box/gate when the film is presented, there is no need for a vacuum system to hold the film edges in place. These advantages reduce and lower the operation cost of the system, as well as reduce noise associated with vacuum devices. Since there are no high accelerating flipping devices, the noise from these devices is eliminated. The film advance mechanism of the present invention runs reliably with ten decibels less noise than previous systems utilizing cams and flipper mechanisms.

The air from the rotary air valve also can be controlled by vanes 143 and an air control block 164. Similarly identified reference numerals denote similar components shown in the other figures and are not discussed separately herein.

The mechanisms which have been described in detail above have been illustrated as being incorporated into a film projector, but the mechanisms may be used for other apparatus employing a film advance mechanism such as for example a motion picture camera, a still frame picture camera, or film splicing mechanism. These and other aspects of the invention will be further understood as hereinafter claimed.

What is claimed is:

1. A film advance mechanism comprising
film input mechanism for moving film along a path past an aperture;
film take-up mechanism taking up film having passed the aperture;
first and second rows of register pins arranged in linear fashion along opposite edges of the path between the film input mechanism and the film take-up mechanism for engaging perforated openings on the film; and
a rotary air valve adjacent the film input mechanism for advancing the film by air.

2. The film advance mechanism of claim 1 wherein the film is formed into a loop by closure of the rotary air valve with the loop propelled past the aperture by opening of the rotary air valve.

3. The film advance mechanism of claim 1 further comprises an air pressure source which provides a constant flow of air to the rotary air valve as the loop of film is formed to propel the loop of film past the aperture.

4. The film advance mechanism of claim 2 wherein the loop in the film is metered by opening and closing the rotary air valve relative to opening and closing a shutter.

5. The film advance mechanism of claim 1 wherein the rotary air valve operates at a pressure of about 2 to about 3 inches of water.

6. A method for advancing film in a motion picture device such as a camera or projector, comprising:
providing a take-off spool to supply film;
forming a loop in the film at an entrance to an aperture position by closure of a rotary air valve.
blowing the loop across the aperture position and toward a film take-up spool by opening the rotary air valve; and
releasing successive loops of film to be blown across the aperture position by timing the opening and closing of the air valve relative to opening and closing a shutter.

7. The method of claim 6 further comprising delivering a constant source of air to the rotary air valve.
